(19) United States
(12) Patent Application Publication
(10) Pub. No.: US 2022/0318464 A1
(43) Pub. Date: Oct. 6, 2022

(54) Machine Learning Data Augmentation for Simulation

(71) Applicant: GM Cruise Holdings LLC, San Francisco, CA (US)

(72) Inventors: Minhao Xu, San Francisco, CA (US); Ignacio Martin Bragado, San Francisco, CA (US); Yibo Zhang, San Francisco, CA (US)

(21) Appl. No.: 17/219,416

(22) Filed: Mar. 31, 2021

(51) Int. Cl. G06F 30/27; G05B 13/02; G05D 1/02

(52) U.S. Cl. CPC G06F 30/27; G05B 13/0265; G05D 1/0212

(57) ABSTRACT

Methods and systems are provided for augmenting simulations with machine learning data. In some aspects, a process can include steps for detecting a lack of data relating to a scenario in a real world environment, generating a simulation of the real world environment based on the detecting of the lack of data relating to the scenario, adding at least one asset to the simulation to satisfy the lack of data relating to the scenario, generating output data based on the simulation with the at least one asset, and updating a machine learning model based on the output data relating to the simulation with the at least one asset.

### BACKGROUND

### 1. Technical Field

The subject technology provides solutions for simulations, and in particular, for augmenting simulations with machine learning data.

### 2. Introduction

Autonomous vehicles are vehicles having computers and control systems that perform driving and navigation tasks that are conventionally performed by a human driver. As autonomous vehicle technologies continue to advance, ride-sharing services will increasingly utilize autonomous vehicles to improve service efficiency and safety. However, autonomous vehicles will be required to perform many of the functions that are conventionally performed by human drivers, such as avoiding dangerous or difficult routes, and performing other navigation and routing tasks necessary to provide a safe and efficient transportation. Such tasks may require the collection and processing of large quantities of data disposed on the autonomous vehicle.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example system environment that can be used to facilitate autonomous vehicle navigation and routing operations, according to some aspects of the disclosed technology.

FIG. 2 illustrates an example system used for training a machine-learning (ML) model to perform semantic labeling, according to some aspects of the disclosed technology.

FIG. 3 illustrates an example block diagram of a semantic labeling system, according to some aspects of the disclosed technology.

FIG. 4 illustrates an example system of utilizing machine learning simulation data, according to some aspects of the disclosed technology.

FIG. 5 illustrates an example of a simulated image, according to some aspects of the disclosed technology.

FIG. 6 illustrates an example process of augmenting a simulation of a scene, according to some aspects of the disclosed technology.

FIG. 7 illustrates examples of virtual road actors utilized in a simulation, according to some aspects of the disclosed technology.

FIG. 8 illustrates an example of introducing diversity to simulations, according to some aspects of the disclosed technology.

FIG. 9 illustrates an example process of Lidar labeling automation, according to some aspects of the disclosed technology.

FIG. 10 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is to augment autonomous vehicle simulations with machine learning data. The present disclosure contemplates that in some instances, assets (e.g., virtual road actors) can augment a simulated scene to provide simulated outputs that can be utilized to train machine learning models or test autonomous vehicle stacks.

Autonomous vehicle (AV) navigation is dependent on the ability of the vehicle to detect and make sense of its surrounding environment. In some implementations these navigation functions are performed by the AV using labeled images of an environment through which the vehicle is navigating. For example, properly labeled images indicating drive able surfaces (e.g., roadways, intersections, crosswalks, and on-ramps, etc.) are used by the AV to make navigation and planning decisions.

In some conventional implementations, image labeling is a manual process performed by human users. In such instances, top-down (2D) images of roadways or other drivable surfaces are labeled, wherein a user indicates geometric boundaries (e.g., polygons) around items of interest (e.g., roadways, crosswalks, or intersections, etc.), and also associates a semantic label with these geometric shapes. By way of example, in labeling an image of a four-way intersection, a human labeler may draw bounding boxes around the four crosswalks, and also indicate a semantic label with each. For example, each bounding box may be tagged to correspond with the label “crosswalk”, or another label that uniquely identifies that particular crosswalk, and its associated bounding box.

Due to the manual nature of such labeling efforts, user-assisted image labeling is time consuming and can be prohibitively expensive, especially in areas where changing roadways require frequent re-labeling and semantic processing. For example, a usual procedure is to obtain road information by actually going to a destination and collecting images, or recording an intersection, and then having human labelers manually label all of the collected information, and from there models could be trained. Moreover, when a data collector goes out into the real world, different objects are observed at different frequencies. For example, typically at any given time, there are more cars than bikes on the road. And typically, there are more pedestrians than bikes, but maybe less pedestrians than cars.

Regarding the models, they are only as good as the data that is provided to them. For example, the models may need to be trained to appreciate the difference between a bicycle and a car. The more instances of cars, bikes, and pedestrians that is trained into a model, the better that the model will perform. As such, models that are solely based on real world captured data are not efficient and may provide erroneous outputs because they are only able to detect too many of one situation type and too few of another type.

Aspects of the disclosed technology address the foregoing limitations of conventional (manual) image labeling and model training techniques by providing augmented simulations that utilize machine-learning (ML) techniques.

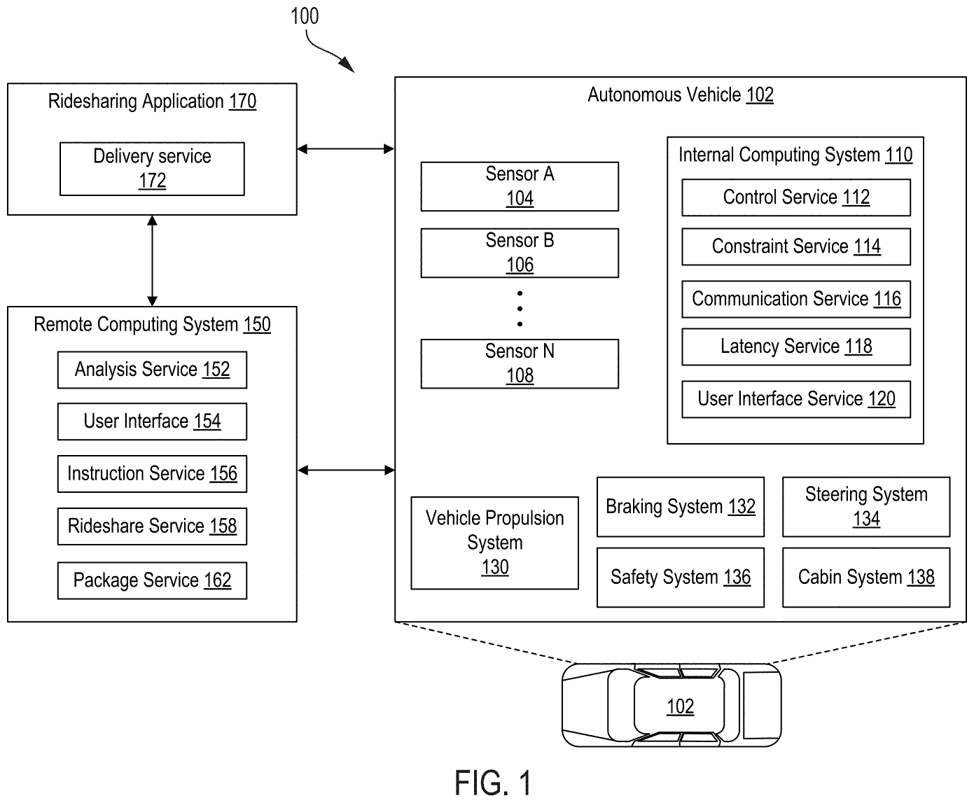

FIG. 1 illustrates an example system environment 100 that can be used to facilitate AV dispatch and operations, according to some aspects of the disclosed technology. Autonomous vehicle 102 can navigate about roadways without a human driver based upon sensor signals output by sensor systems 104-106 of autonomous vehicle 102. Autonomous vehicle 102 includes a plurality of sensor systems 104-106 (a first sensor system 104 through an Nth sensor system 106). Sensor systems 104-106 are of different types and are arranged about the autonomous vehicle 102. For example, first sensor system 104 may be a camera sensor system and the Nth sensor system 106 may be a Light Detection and Ranging (LIDAR) sensor system. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it is understood that more or fewer sensors may be coupled to the autonomous vehicle 102.

Autonomous vehicle 102 further includes several mechanical systems that are used to effectuate appropriate motion of the autonomous vehicle 102. For instance, the mechanical systems can include but are not limited to, vehicle propulsion system 130, braking system 132, and steering system 134. Vehicle propulsion system 130 may include an electric motor, an internal combustion engine, or both. The braking system 132 can include an engine brake, brake pads, actuators, and/or any other suitable componentry that is configured to assist in decelerating autonomous vehicle 102. In some cases, braking system 132 may charge a battery of the vehicle through regenerative braking. Steering system 134 includes suitable componentry that is configured to control the direction of movement of the autonomous vehicle 102 during navigation.

Autonomous vehicle 102 further includes a safety system 136 that can include various lights and signal indicators, parking brake, airbags, etc. Autonomous vehicle 102 further includes a cabin system 138 that can include cabin temperature control systems, in-cabin entertainment systems, etc.

Autonomous vehicle 102 additionally comprises an internal computing system 110 that is in communication with sensor systems 180 and systems 130, 132, 134, 136, and 138. Internal computing system 110 includes at least one processor and at least one memory having computer-executable instructions that are executed by the processor. The computer-executable instructions can make up one or more services responsible for controlling autonomous vehicle 102, communicating with remote computing system 150, receiving inputs from passengers or human co-pilots, logging metrics regarding data collected by sensor systems 180 and human co-pilots, etc.

Internal computing system 110 can include a control service 112 that is configured to control operation of vehicle propulsion system 130, braking system 132, steering system 134, safety system 136, and cabin system 138. Control service 112 receives sensor signals from sensor systems 180 as well communicates with other services of internal computing system 110 to effectuate operation of autonomous vehicle 102. In some embodiments, control service 112 may carry out operations in concert one or more other systems of autonomous vehicle 102.

Internal computing system 110 can also include constraint service 114 to facilitate safe propulsion of autonomous vehicle 102. Constraint service 116 includes instructions for activating a constraint based on a rule-based restriction upon operation of autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of control service 112.

The internal computing system 110 can also include communication service 116. The communication service 116 can include both software and hardware elements for transmitting and receiving signals from/to the remote computing system 150. Communication service 116 is configured to transmit information wirelessly over a network, for example, through an antenna array that provides connectivity using one or more cellular transmission standards, such as long-term evolution (LTE), 3G, 5G, or the like.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions etc.

Internal computing system 110 can also include latency service 118. Latency service 118 can utilize timestamps on communications to and from remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, latency service 118 can enable other systems of autonomous vehicle 102 or a passenger to make necessary decisions or to provide the needed feedback.

Internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 140 regarding reporting data for training and evaluating machine learning algorithms, requesting assistance from remote computing system 150 or a human operator via the remote computing system 150, software service updates, rideshare pickup and drop off instructions, etc.

Remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102.

Remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

Remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

Remote computing system 150 can also include rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

As discussed in further detail below, machine-learning models of the disclosed technology can be based on machine learning systems that include generative adversarial networks (GANs) that are trained, for example, using pairs of labeled and unlabeled image examples. In some aspects, unlabeled (input) images can be provided based on LiDAR map data for example, that is produced from a rasterized high-resolution three-dimensional LiDAR map. As such, the disclosed labeler can perform image-to-image translation, wherein input images (based on LiDAR data) are labeled through the insertion of geometric bounding boxes and association with semantic labels. Labeled image outputs provided by the labeling system can then be utilized by AVs to quickly determine driving boundaries, and to facilitate navigation and route planning functions.

As understood by those of skill in the art, machine-learning based classification techniques can vary depending on the desired implementation. For example, machine-learning classification schemes can utilize one or more of the following, alone or in combination: hidden Markov models, recurrent neural networks (RNNs), convolutional neural networks (CNNs); Deep Learning networks, Bayesian symbolic methods, general adversarial networks (GANs), support vector machines, image registration methods, and/or applicable rule-based systems. Where regression algorithms are used, they can include but are not limited to: a Stochastic Gradient Descent Regressors, and/or Passive Aggressive Regressors, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

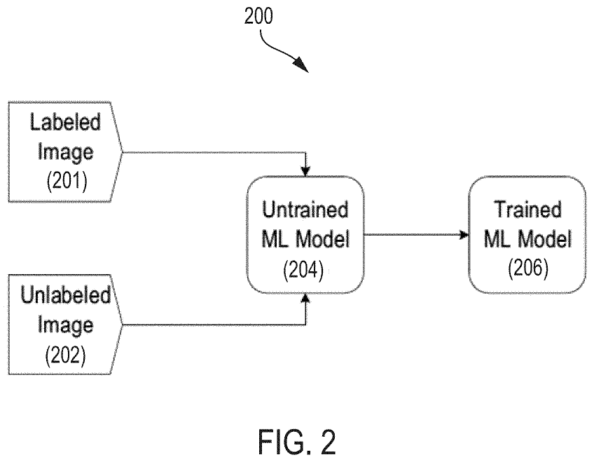

FIG. 2 illustrates an example system 200 used for training a machine-learning (ML) model to perform bounding box labeling (geometric labeling) and semantic labeling, according to some aspects of the technology. As illustrated in system 200, examples of labeled images 201 and unlabeled images 202 are provided to untrained ML model 204. Untrained ML model 204 can include one or more general adversarial networks (GANs), which are configured to learn labeling conventions based on labeled image examples (201). For instance, untrained ML model 204 can learn how geometric bounding boxes (polygons) and semantic labels are to be associated with certain image features. In some aspects, bounding boxes can be colored based on the semantic association. For example, crosswalks can be bounded by yellow colored polygons, whereas intersections may be bounded by red polygons, etc. In other implementations, semantic labels such as metadata word tags can be associated with bounding boxes around salient image features, or associated with the image features directly.

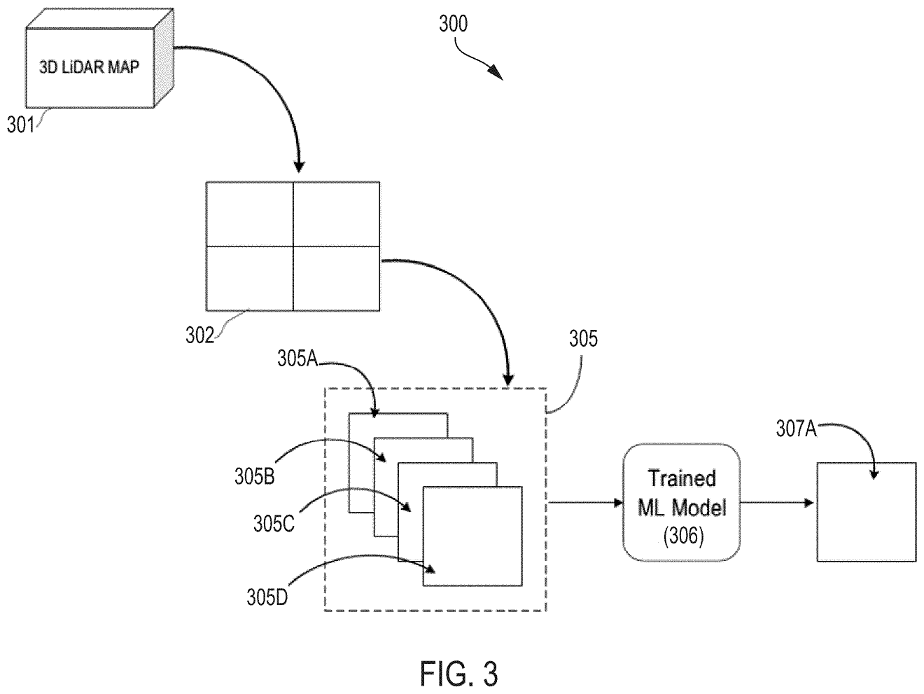

FIG. 3 illustrates a conceptual block diagram of a semantic labeling system 300, according to some aspects of the technology. In system 300, a LiDAR map (e.g., a high-resolution 3D map) 301 is first converted into a two-dimensional (2D) map 302, for example, using an inverse perspective mapping process or other dimensional reduction technique. The 2D LiDAR map 302 is then segmented (e.g., rasterized) into a plurality of image segments or tiles 305 (e.g., tiles 305A, 305B, 305C, and 305D). Each tile is then provided to a trained ML labeling model, such as trained ML model 306. Segmentation of the 2D LiDAR map can improve label processing by reducing the size of input data provided to ML model 306. Tiling can also facilitate parallel processing, for example, utilizing multiple labeling models (not shown) in a parallel processing architecture.

The outputs of ML model 306 are labeled image tiles. For example, labeled tile 307A can represent a labeled image-to-image transformation resulting from processing performed on 2D LiDAR image input tile 305A. That is, labeled tile 307A can include one or more bounding boxes (polygons) that identify image features salient to AV navigation, such as, crosswalks, sidewalks, roadways, on-ramps, driveways, parking lots, parking spaces, bike-lanes, road-signs, and/or traffic lights, etc. As discussed above, bounding boxes can be associated with semantic labels. In some approaches, semantic labeling associations can be indicated by color coding, wherein bounding box color indicates the enclosed image feature. Alternatively (or additionally) semantic labeling can be performed using metadata tags, for example that provide a word-label for the associated image feature i.e., “crosswalk”, “intersection”, or “lane boundary”, etc.

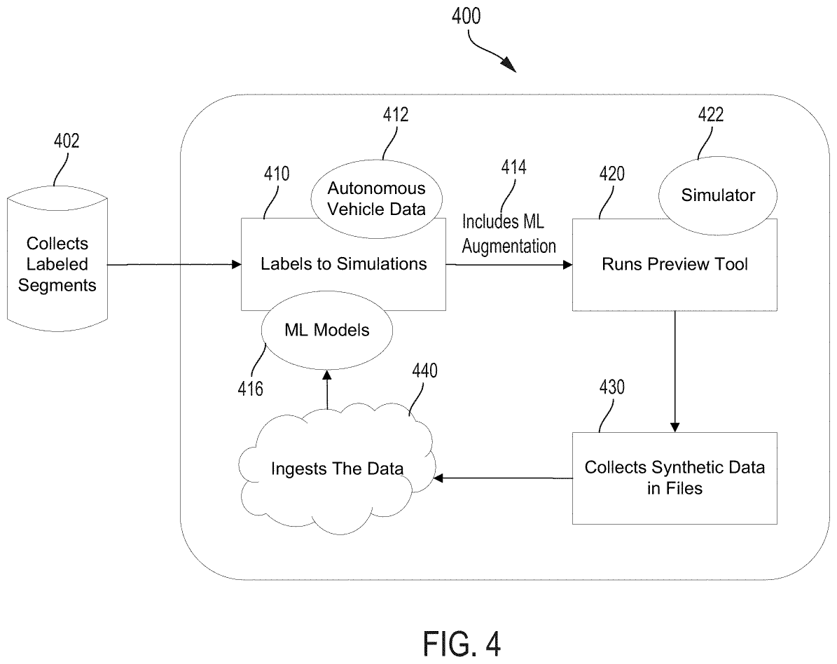

FIG. 4 illustrates an example system of utilizing machine learning simulation data 400, according to some aspects of the disclosed technology. Simulation system 400 can automatically generate assets or virtual road actors based on a requested ratio. Different ratios and simulations can then be utilized to train machine learning data. For example, simulation system 400 allows for simulating intersection, corner scenarios and then augmenting the scenario with virtual road actors to train machine learning models as described herein.

In some implementations, labeled segments 402 can be received and utilized by simulation system 400. Labeled segments 402 can be collected from autonomous vehicles of an autonomous vehicle fleet. Labeled segments 402 can further be received from a central autonomous vehicle control system that collects camera and sensor data from the autonomous vehicle fleet.

In other implementations, simulation system 400 can include utilizing received labeled segments 402 to generate base simulations 410. Simulation system 400 can further supplement simulations 410 by utilizing autonomous vehicle data 412 from the autonomous vehicle fleet including camera, lidar, radar data, and internal node data to generate simulations of tasks, structures, landscapes, objects, traffic signs, and any other type of simulation suitable for the intended purpose and understood by a person of ordinary skill in the art.

Simulations 410 can then be augmented 414 to generate different scenarios by utilizing assets, as described herein, and machine learning models 416 (e.g., an autonomous vehicle entering an intersection), which can then be utilized to update machine learning models 416 and generate more accurate, augmented simulations. For example, if real world data included more cars than bikes, machine learning models may only be able to recognize scenarios with the same number of cars and bikes. Simulation system 400 also contemplates augmenting simulations 410 to include scenarios where there may be more bikes than cars and where there are the same number of cars and bikes. In some implementations, where the scenario includes more cars than bikes, simulation system 400 can recognize the deficiency in scaling ratios of cars to bikes, and automatically generate a simulation with assets (e.g., virtual road actor) based on unavailable or requested ratios of objects (e.g., assets). In this instance, a request may be received by simulation system 400 to increase the ratio of bikes in the next simulation, thereby providing enough representation for the objects to recognize the different classes.

Types of classes as described herein can include animals, barriers, buses, bicycles, cars, objects (e.g., both static and dynamic objects), heavy vehicles, motorcycles, people, trains, trucks, and atmospheric issues. The different types of classes affect simulation system 400 as the behavior and response of the autonomous vehicle is different depending on the type of class that is present. For example, while it may be acceptable to continue moving in the presence of a small detected animal to prevent a dangerous maneuver or to venture through atmospheric conditions, other objects might require avoidance at a higher cost. Also, some types of classes may affect the autonomous vehicle in different ways by redirecting the autonomous vehicle to a different path. For example, the autonomous vehicle may encounter road signs or construction cones that may dictate the path of which the autonomous vehicle may travel.

Machine learning models require data to be trained properly. If there are gaps in the data, the machine learning models may not provide expectant results. For example, road construction is a rare condition to experience in the real world. If there is not much data on road construction, this scenario can be a bottleneck for development. Based on this lack of data, simulation system 400 can increase the number of road constructions in simulations 410 by running simulations 410 with a higher ratio of road construction, thereby generating more samples of these types of scenarios, which can then be utilized to train machine learning models 416. This process is cost effective in that less test vehicles have to be sent out to collect data and less hours are required of a labeler to manually label data.

In some implementations, real world data can be collected by an autonomous vehicle by recording its surroundings via cameras and sensors as described herein. For example, the autonomous vehicle can be driving in San Francisco on ones of its many roads. While driving, the autonomous vehicle records data including the car's position, data relating to the surrounding vehicles, and data relating to pedestrians the environment. Simulation system 400 can then utilize all of this data and generate a simulation of the same scenario (e.g., environment). This collection of data can also be utilized by simulation system 400 to train machine learning models 416.

Thereafter, simulation system 400 can augment the generated simulation 410 by adding different virtual road actors, including their respective ratios (e.g., the total number of each type of virtual road actor). Simulation system 400 can also move or change the positions of the virtual road actors. For example, pedestrian virtual road actors can be repositioned to a different sidewalk to represent a scenario where a large group of pedestrians may exist at a given time (e.g., at the end of a concert). Simulation system 400 can also adjust velocities of the virtual road actors (e.g., traveling vehicles) if simulation system 400 is generating a multi-frame simulation or a single frame simulation. All of these features assist simulation system 400 by enhancing and enriching the data diversity, which can then be utilized to train machine learning model 416. Scenarios may also be categorized. For example, scenarios that belong to a “long term category” may be considered as scenarios that rarely occur, yet are important to the simulation system 400. In some implementations, long term categories of scenarios can include generating and investigating vehicles with open doors, cyclists driving in the opposite direction in one lane roads, and ensuring correct behavior under a flock of birds.

In other implementations, simulation system 400 can utilize autonomous vehicle data 412 relating to object movement (e.g., pedestrian movement) to supplement simulated movements of the object to be more realistic. For example, it may be preferable to place more simulated pedestrians onto sidewalks of simulation 410 that move around realistically. There are certain actions and movements that real pedestrians do, and other actions and movements that real pedestrians do not do. For example, it may not be preferable to have the simulated pedestrians collide with one another. It may also not be preferable to have the simulated pedestrians disobey traffic signals and incorrectly walk into a street lane, potentially being struck by a vehicle. Assumptions and algorithms can be utilized by simulation system 400 to produce trajectories of the simulated pedestrians that are relatively random, yet not so random that the simulated pedestrian would collide with another pedestrian. As described herein, simulation system 400 can utilize autonomous vehicle data 412 to supplement the trajectories of the simulated pedestrian to move about more realistically, thereby providing more accurate simulations that can then be outputted to train machine learning models 416. Including object movement (e.g., animation of the object) in simulation system 400 can provide more realism as time evolves and as simulation system 400 is utilized. Object movement also provides for more diversity within the same scene. For example, pedestrians are not rigid bodies. As such, animation of a pedestrian's different body parts allows ML models 416 to be exposed to many different poses and body gestures a realistic pedestrian, which may be adopted by ML models 416 or simulation system 400.

As previously discussed, real world data is expensive because data collecting vehicles have to be sent out into the real world to record data, which is then manually labeled by laborers. Instead of collecting real world data, simulation system 400 can generate simulation data on a large scale. Furthermore, simulations 410 generated by simulation system 400 can also be utilized for different types of sensors. For example, similar to how data augmentation generates scenarios with virtual road actors, simulation system 400 can generate simulations with different sensor placements. In one example, if simulation system 400 is simulating with a current test vehicle with a first type of sensors, simulation system 400 can also simulate with a new type of sensor. This provides better diversity and scale to simulation system 400, which can then be utilized to train machine learning models 416.

Simulation system 400 can also include a preview tool 420 that utilizes a simulator 422 to preview simulations 410 generated by simulation system 400. The simulator 422 can include an application that is based on a 3D matrix simulator. The 3D matrix simulator is a simulating software that is configured to render a complete 3D world and evolve the 3D world over time, while also simulating all of the sensor data collected and received by simulation system 400. Preview tool 420 can then run a cloud version of an autonomous vehicle stack against simulation 410 that was generated by simulation system 400 by utilizing real world autonomous vehicle data 412 and machine learning augmentations 414.

In some implementations, simulation system 400 can include collecting results of simulation 410 (e.g., synthetic data) into files (e.g., data can be aggregated into a data file having a predetermined data schema). In some implementations, sensor data can include, but not be limited to: 1) camera images captured in simulation (e.g., RGB images and depth images); lidar point clouds (e.g., stored in annotated messages including 3D locations (e.g., xyz), intensity (e.g., how reflective a surface may be), and range (e.g., distance from a sensor to a designated point); and radar point clouds (e.g., stored in annotated messages including 3D locations (e.g., xyz), magnitude (e.g., related to electromagnetic properties of an object), and velocity (e.g., Doppler effect).

Labels can include, but not be limited to: 1) object data in a scene including 3D transforms, classification, and other attributes (e.g., according to object labeling requirements); 2) 2D bounding boxes for objects in images and 3D bounding boxes for objects in point clouds, the object bounding boxes can also be synced across different sensors; 3) pixelwise (e.g., images) and pointwise (e.g., point clouds) labels, which assists in determining which object belongs to which pixel/point; and 4) other metadata (e.g., sensor configuration, ego vehicle transform, and time data).

In some implementations, sensor data and labels (e.g., synthetic data) can be aggregated by simulation system 400 into data files. For example, sensor data can be uploaded onto a cloud storage, while a data file can include URLs to synthetic data. Labels can also be stored in the data file and uploaded onto the cloud storage. Object and sensor data, generated at the same simulation frame, can be stored in the same row of the data file. The database in the cloud of the simulation system 400 can then ingest the data files and generate a ground truth dataset, where users can query sensor data.

Synthetic data 430 of simulation system 400 can then be ingested to generate an output that can be utilized by simulation system 400 to update simulations 410, train and retrain machine learning models 416, test the autonomous vehicle stack, etc. In some implementations, simulation system 400 can include update simulations that execute trained machine learning models based on the synthetic data. Simulation system 400 can compare model predictions and synthetic labels, or compare road data and synthetic data. This comparison can be utilized by simulation system 400 demonstrate how the simulation data differs from the real world data.

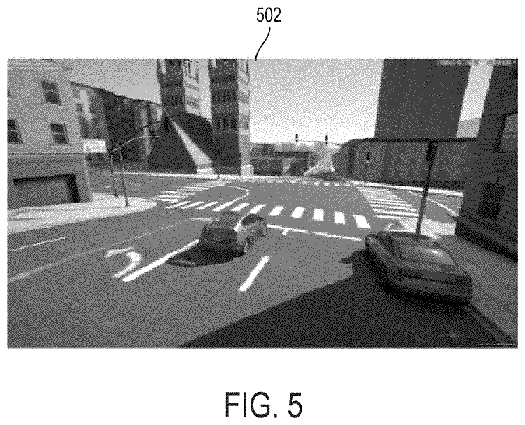

FIG. 5 illustrates an example of a simulated image 502, according to some aspects of the disclosed technology. Generating an autonomous vehicle simulation can be resource hungry, but not as consuming as a decentralized form of communication. Simulation system 400 can include one or more graphics processing unit (GPU) (e.g., gcp-gpu-440 workers). In some instances, one hydra worker can generate from 1 to 100 frames of data and take about 1 to 30 minutes to complete. For the example, the table 1 below illustrates sensor configurations and the time it takes for a hydra worker to complete.

TABLE 1

| | Single frame, | Single frame, | Multi-frame, |
|---|---|---|---|
| Sensor Configuration | all sensors | lidar only | all sensors |
| Time on Hydra per | 1.7 | 1.25 | 0.7 |
| Worker Frame (minutes) | | | |

The single frame, all sensor type configuration is approximately 1.7 minutes of Hydra per worker frame time. The single frame, lidar only type configuration is approximately 1.25 minutes of Hydra per worker frame time. The multi-frame, all sensors type configuration is approximately 0.7 minutes of Hydra per worker frame time. In other examples, e.g., a lidar only type configuration, results may include 526K (9×) and 14 hours using a gcp-gpu-440. Single frame, as described herein, can include scenes that are captures at a particular position and time, but without continuity in time (e.g., without velocity information). Multi-frames, as described herein, can include a series of frames relating to the scene that provides a time evolution of the scene (e.g., including velocity information of objects in the scene).

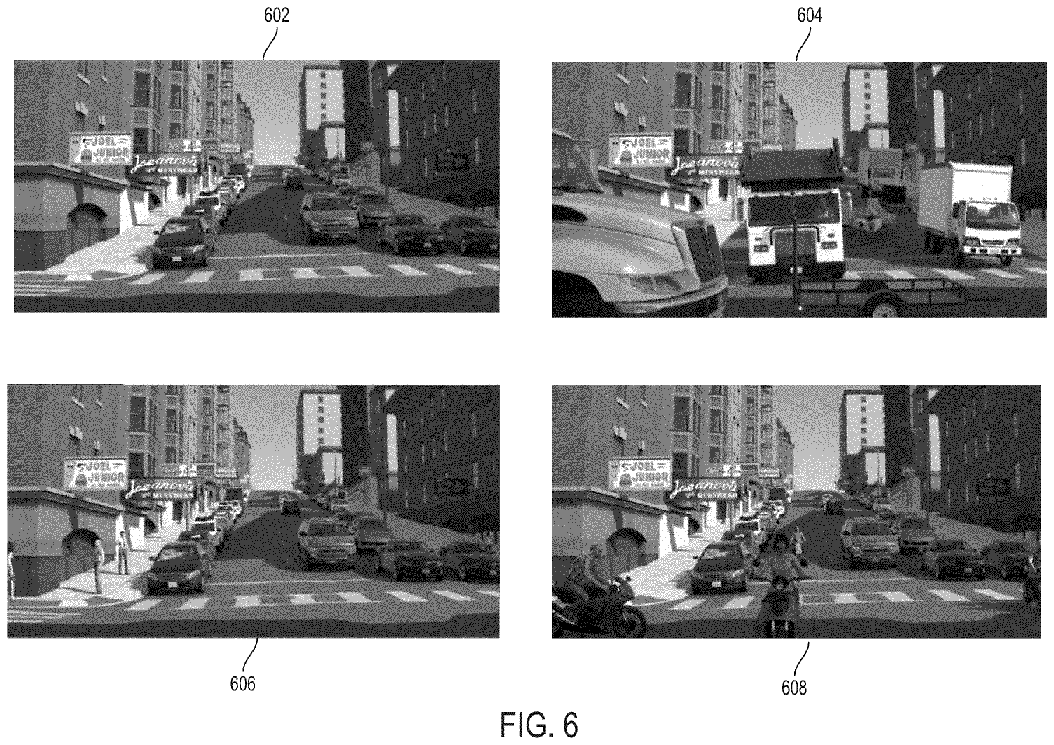

FIG. 6 illustrates an example process of augmenting a simulation of a scene 600, according to some aspects of the disclosed technology. Process 600 may be facilitated by utilized simulation system 400. If customized data is needed and is not well represented by limitations of road data, simulation 400 can be utilized to augment a scene to: 1) bias assets (e.g., cyclist, vehicles, pedestrians, etc.) towards a particular ground truth classification (e.g., include more cyclists); 2) add extra assets of any type to be moving, stationary, between traffic lanes, in parking areas, on sidewalks, etc.; 3) remove asset types from the scene; and 4) modify how the assets are translated from the road data into the simulation data (e.g., replace 15% of pedestrians with construction cones).

Referring to FIG. 6, a scene 602 is illustrated where road data is insufficient based on the lack of data relating to types of assets and their respective positions and movements. For example, there may not be sufficient road data to instruct an autonomous vehicle on how to proceed through the intersection of scene 602. The more simulations that are available to the autonomous vehicle, the better it can make decisions to properly proceed through the intersection of scene 602. As such, simulation system 400 can generate simulations by augmenting simulation scenes (e.g., scene 602) that can then be provided to the autonomous vehicle fleet to navigate more efficiently, even though there was none or insufficient real-world road data corresponding to scene 602.

Simulation system 400 can scale and augment scene 602 by removing cars while adding trucks to various lanes of the intersection 604. Simulation system 400 can also scale and augment scene 602 by adding pedestrians to the various sidewalks 606. Furthermore, simulation system 400 can scale and augment scene 602 to add motorcycles to various lanes of the intersection 608.

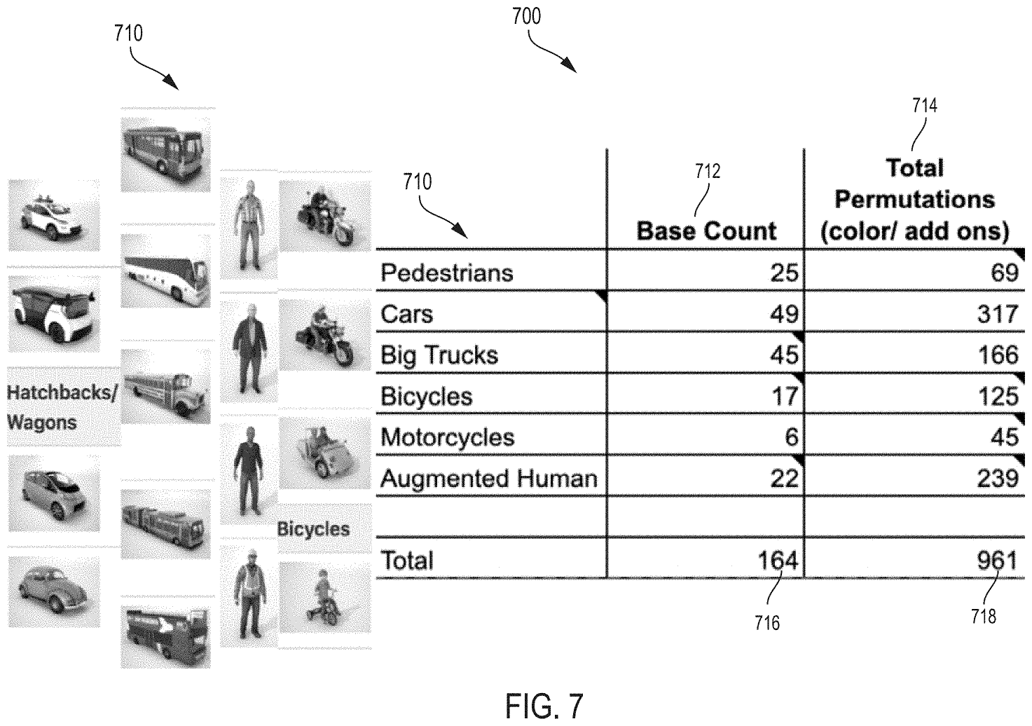

FIG. 7 illustrates examples of virtual road actors utilized in a simulation, according to some aspects of the disclosed technology. For example, virtual road actors 710 (e.g., assets as described herein) can include pedestrians, cars, big trucks, bicycles, motorcycles, augments humans, and any other type of asset suitable for the intended purpose and understood by a person of ordinary skill in the art. Virtual road actors 710 can include corresponding base counts 712 and total permutations 714 such as color and add-ons. For example, pedestrians can include a base count of 25 and a total permutation value of 69; cars can include a base count of 49 and a total permutation value of 317; big trucks can include a base count of 45 and total permutation value of 166; bicycles can include a base count of 17 and a total permutation value of 125; motorcycles can include a base count of 6 and include a total permutation value of 45; and augmented humans can include a base count of 22 and a total permutation value of 239, for a total base count 176 of 164 and a total permutation count 718 of 961.

In some implementations, simulation scenarios can include multiple asset categories such as pedestrians, cars, heavy vehicles, bicycles, motorcycles, etc. For each category, there is a base number for the different assets. For example, the category for vehicles can include various makes, models, years, and types of vehicles. In addition to the base asset, there may also be different add-ons for each asset. For example, for the base asset, add-ons such as color, position, and heading angle can be changed. Moreover, simulation system 400 can change a door to be open or closed, a window to be open or closed, and have a person sitting in the driver's seat. The different permutations for the add-ons can increase the overall diversity of the asset and scenario significantly, which is beneficial for input data quality for machine learning model training.

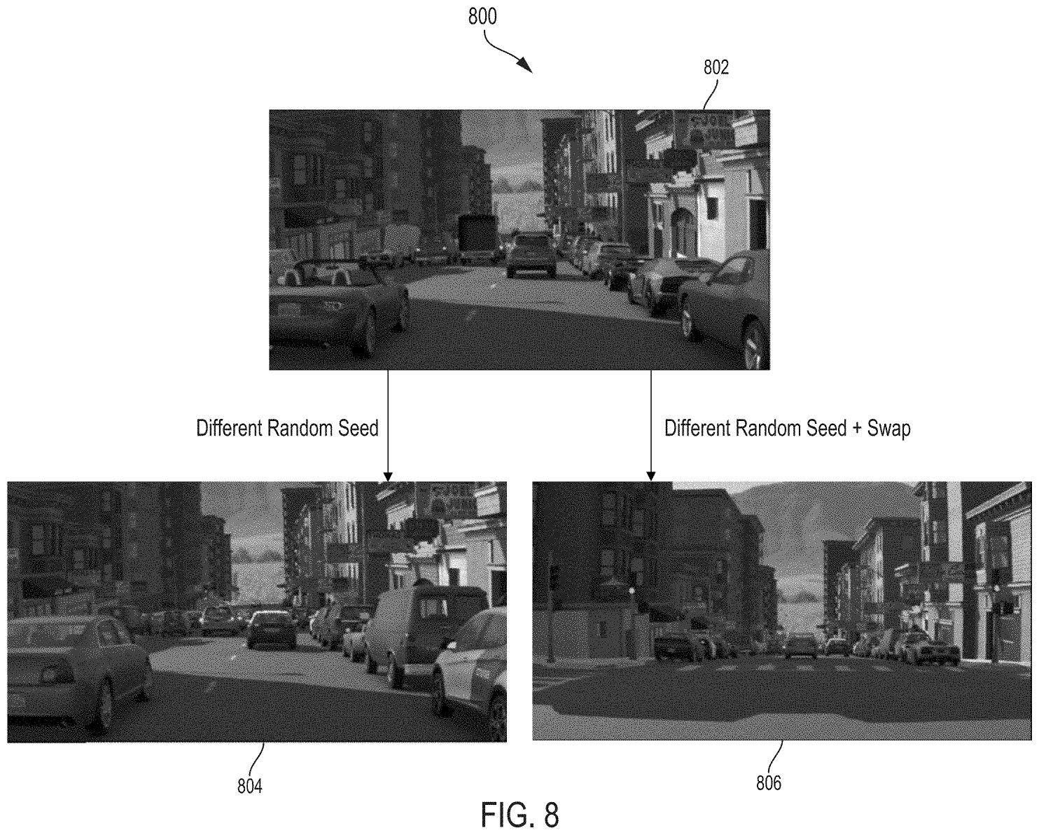

FIG. 8 illustrates an example of introducing diversity to simulations 800, according to some aspects of the disclosed technology. Simulation system 400 can also utilize extra diversity for scenes that can be obtained from the same scene 802. For example, simulation system 400 can iterate the same scene with different random seeds 804. Simulation system 400 can also swap the car from scene 802 with a virtual road actor to change the point of view 806. In some implementations, random numbers may not be generated by computers or may be very expensive to generate. Instead, pseudo-random number generators may be utilized to generate a series of numbers resembling a random number distribution. These functions can be deterministic and produce a similar output depending on a single input (e.g., a random seed).

In some implementations, simulation system 400 can include swapping, which improves augmented simulations by changing the point of view of the vehicle, thereby producing a different set of data from the same input. The process of changing the point of view of the vehicle provides iterating benefits from an augmented simulation by reusing the same frame and point of view, but interchanging assets in the scene. This provides a new scene that, while still resembling the original one in asset types and positions, is nonetheless different by having different assets. For example, if the asset is a vehicle, simulation system 400 can switch between different vehicle models and colors.

By changing point of view 806 (e.g., the point of view of an autonomous vehicle), additional simulations can be generated based on the new point of view. For example, if point of view 806 was adjusted to be in the middle of a traffic light, that would not be realistic because cars are not in the middle of traffic lights. As such, a determination may be required to determine how to change point of view 806 while still having a realistic point of view. And in that sense, if in reality, the data collected by the autonomous vehicle 412 includes data that shows the position of a different vehicle proximate to the autonomous vehicle, simulation system 400 can change point of view 806 to the perspective of the different vehicle with an assurance that point of view 806 is a realistic point of view since a real vehicle was already known to be in that position. From this new point of view 806, simulation system 400 can then run new simulations 410 and gather more data that can be utilized to train machine learning models 416.

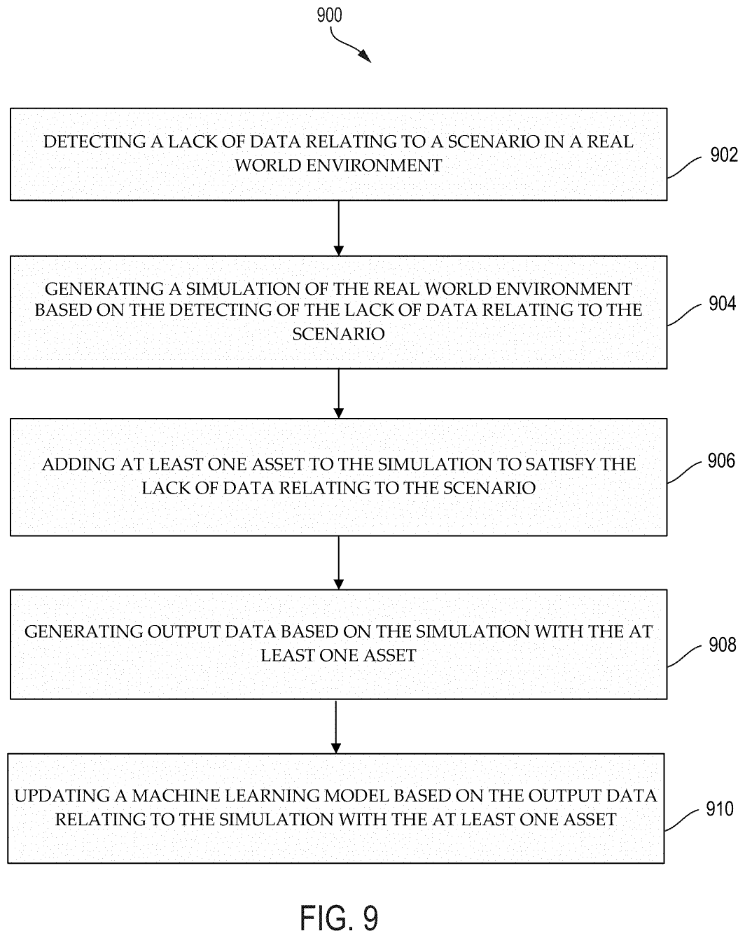

Having disclosed some example system components and concepts, the disclosure now turns to FIG. 9, which illustrates an example method 900 for augmenting simulations with machine learning data. The steps outlined herein are exemplary and can be implemented in any combination thereof, including combinations that exclude, add, or modify certain steps.

At step 902, method 900 can include detecting, at a simulation system, a lack of data relating to a scenario in a real world environment. The lack of data to the scenario can include objects that are not present in the scenario of the real world environment.

At step 904, method 900 can include generating, by the simulation system, a simulation of the real world environment based on the detecting of the lack of data relating to the scenario.

At step 906, method 900 can include adding, by the simulation system, at least one asset to the simulation to satisfy the lack of data relating to the scenario. The at least one asset can include a virtual road actor that is simulated to move realistically. The virtual road actors can include at least one of a pedestrian, a vehicle, a motorcycle, and a cyclist. The adding of the at least one asset to the simulation can include positioning the at least one asset in a location in the simulation that is not present in a corresponding location of the real world environment.

At step 908, method 900 can include generating, by the simulation system, output data based on the simulation with the at least one asset. The output data can be synthetic data including a resultant simulation of the simulation and the at least one asset.

At step 910, method 900 can include updating, by the simulation system, a machine learning model based on the output data relating to the simulation with the at least one asset.

Method 900 can further include providing, by the simulation system, the updated machine learning model to an autonomous vehicle to assist in automated driving.

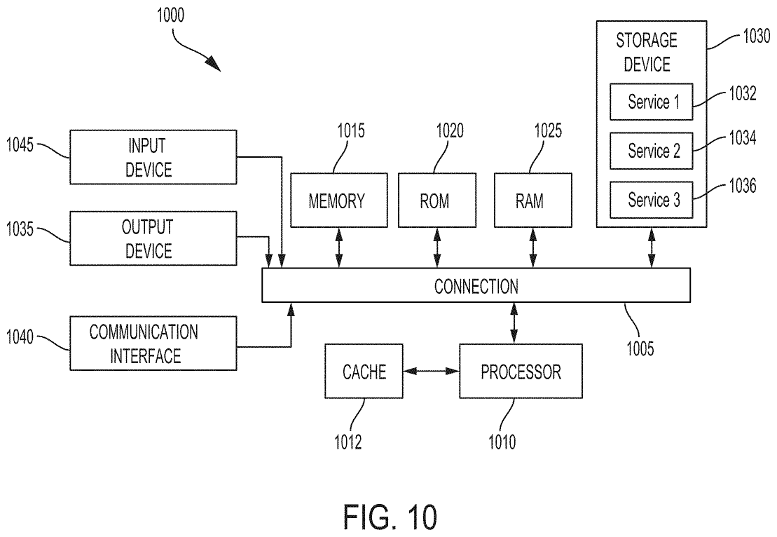

FIG. 10 illustrates an example processor-based system with which some aspects of the subject technology can be implemented. For example, processor-based system 1000 that can be any computing device making up internal computing system 110, remote computing system 150, a passenger device executing the rideshare app 170, internal computing device 130, or any component thereof in which the components of the system are in communication with each other using connection 1005. Connection 1005 can be a physical connection via a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (CPU or processor) 1010 and connection 1005 that couples various system components including system memory 1015, such as read-only memory (ROM) 1020 and random-access memory (RAM) 1025 to processor 1010. Computing system 1000 can include a cache of high-speed memory 1012 connected directly with, in close proximity to, and/or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms known to those of skill in the art. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. By way of example computer-executable instructions can be used to implement perception system functionality for determining when sensor cleaning operations are needed or should begin. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method comprising:
detecting, at a simulation system, a lack of data relating to a scenario in a real world environment;
generating, by the simulation system, a simulation of the real world environment based on the detecting of the lack of data relating to the scenario;
adding, by the simulation system, at least one asset to the simulation to satisfy the lack of data relating to the scenario;
generating, by the simulation system, output data based on the simulation with the at least one asset; and
updating, by the simulation system, a machine learning model based on the output data relating to the simulation with the at least one asset.

2. The computer-implemented method of claim 1, wherein the lack of data to the scenario includes objects that are not present in the scenario of the real world environment.

3. The computer-implemented method of claim 1, wherein the at least one asset includes a virtual road actor that is simulated to move realistically.

4. The computer-implemented method of claim 3, wherein the virtual road actor include at least one of a pedestrian, a vehicle, a motorcycle, and a cyclist.

5. The computer-implemented method of claim 1, wherein the adding of the at least one asset to the simulation includes positioning the at least one asset in a location in the simulation that is not present in a corresponding location of the real world environment.

6. The computer-implemented method of claim 1, wherein the output data is synthetic data including a resultant simulation of the simulation and the at least one asset.

7. The computer-implemented method of claim 1, further comprising providing, by the simulation system, the updated machine learning model to an autonomous vehicle to assist in automated driving.

8. A simulation system comprising:
one or more processors; and
at least one computer-readable storage medium having stored therein instructions which, when executed by the one or more processors, cause the simulation system to:
detect a lack of data relating to a scenario in a real world environment;
generate a simulation of the real world environment based on the detection of the lack of data relating to the scenario;
add at least one asset to the simulation to satisfy the lack of data relating to the scenario;
generate output data based on the simulation with the at least one asset; and
update a machine learning model based on the output data relating to the simulation with the at least one asset.

9. The simulation system of claim 8, wherein the lack of data to the scenario includes objects that are not present in the scenario of the real world environment.

10. The simulation system of claim 8, wherein the at least one asset includes a virtual road actor that is simulated to move realistically.

11. The simulation system of claim 10, wherein the virtual road actor include at least one of a pedestrian, a vehicle, a motorcycle, and a cyclist.

12. The simulation system of claim 8, wherein the addition of the at least one asset to the simulation includes positioning the at least one asset in a location in the simulation that is not present in a corresponding location of the real world environment.

13. The simulation system of claim 8, wherein the output data is synthetic data including a resultant simulation of the simulation and the at least one asset.

14. The simulation system of claim 8, wherein the instructions which, when executed by the one or more processors, cause the system to provide the updated machine learning model to an autonomous vehicle to assist in automated driving.

15. A non-transitory computer-readable storage medium comprising:
instructions stored on the non-transitory computer-readable storage medium, the instructions, when executed by one more processors, cause the one or more processors to:
detect a lack of data relating to a scenario in a real world environment;
generate a simulation of the real world environment based on the detection of the lack of data relating to the scenario;
add at least one asset to the simulation to satisfy the lack of data relating to the scenario;
generate output data based on the simulation with the at least one asset; and
update a machine learning model based on the output data relating to the simulation with the at least one asset.

16. The non-transitory computer-readable storage medium of claim 15, wherein the lack of data to the scenario includes objects that are not present in the scenario of the real world environment.

17. The non-transitory computer-readable storage medium of claim 15, wherein the at least one asset includes a virtual road actor that is simulated to move realistically, the virtual road actor including at least one of a pedestrian, a vehicle, a motorcycle, and a cyclist.

18. The non-transitory computer-readable storage medium of claim 15, wherein the addition of the at least one asset to the simulation includes positioning the at least one asset in a location in the simulation that is not present in a corresponding location of the real world environment.

19. The non-transitory computer-readable storage medium of claim 15, wherein the output data is synthetic data including a resultant simulation of the simulation and the at least one asset.

20. The non-transitory computer-readable storage medium of claim 15, wherein the instructions, when executed by the one more processors, cause the one or more processors to provide the updated machine learning model to an autonomous vehicle to assist in automated driving.
